(19) United States
(12) Patent Application Publication
(10) Pub. No.: US 2013/0339077 A1
(43) Pub. Date: Dec. 19, 2013

(54) Automated Delegation

(71) Applicants: Mark E. Maresh, Cave Creek, AZ (US); Eric A. Stegner, Durham, NC (US); Kimberly I. Stegner, Durham, NC (US)

(72) Inventors: Mark E. Maresh, Cave Creek, AZ (US); Eric A. Stegner, Durham, NC (US); Kimberly I. Stegner, Durham, NC (US)

(73) Assignee: INTERNATIONAL BUSINESS MACHINES CORPORATION, Armonk, NY (US)

(21) Appl. No.: 13/526,498

(22) Filed: Jun. 18, 2012

(51) Int. Cl. G06Q 10/06

(52) U.S. Cl. 705/7.19; 705/7.13; 705/7.18

(57) ABSTRACT

Automated delegation may be used, by way of example, with an electronic calendar application to delegate attendance at a meeting or other event and with an email application to delegate responsibility for handling an inbound email message. Parameter values are predefined, describing various characteristics of potential delegates to whom responsibility may by delegated. When delegation is triggered, these parameter values are checked to select from among the potential delegates. Potential delegates may be ranked, in which case the highest-ranked potential delegate may be consulted first, with next-highest-ranked potential delegates iteratively consulted if the delegation is not accepted. The original request preferably shows an indication of the delegation status, so that the original meeting invitee or original email message recipient can maintain awareness of the delegation and can manage responsibility for the original request as needed.

### BACKGROUND OF THE INVENTION

The present invention relates to computer programming, and deals more particularly with automated delegation in applications such as electronic calendar and electronic mail (hereinafter, “email”) applications.

Electronic calendar applications are used extensively in many people's daily work, as well as in their personal lives. Electronic calendars often contain a wealth of information about their owner. For example, an individual may use an electronic calendar to maintain information about his work schedule, his meetings and other appointments, his vacation and business travel plans (including when he will be away, which flights or other transportation he will use, where he can be reached while away, who he may visit while away, etc.), phone calls that need to be made at particular times, and so forth. Examples of electronic calendar systems include Microsoft Outlook® and Lotus Notes®, which also allows a user to create entries on his calendar for other people. For example, a secretary might have calendar entries for his own schedule, but also keep information about his manager's appointments on his manager's calendar (and optionally his own calendar as well). Such systems are quite popular among users. (“Outlook” is a registered trademark of Microsoft Corporation, and “Lotus Notes” is a registered trademark of International Business Machines Corporation.)

Email applications are also used extensively by many people, and have become pervasive as a means of communications. As is well known, email systems accept electronic messages and store them for delivery; the delivery occurs when the recipient logs on to the email system and receives his or her waiting messages. A display paradigm for email typically includes a virtual “in basket” where messages which have been received by a particular email application user are accessible for viewing. Example email systems include Outlook Express from Microsoft Corporation and Lotus Notes.

### BRIEF SUMMARY OF THE INVENTION

The present invention defines techniques for automated delegation, comprising: defining parameter values for each of a plurality of potential delegates; responsive to a subsequent request for delegating an event, automatically attempting a delegation using the predefined parameter values for the potential delegates; and if any obtained response indicates successful delegation of the event, updating a status of the event to indicate the delegation and otherwise, updating the status of the event to indicate failure of the delegation attempt. Automatically attempting the delegation preferably comprises: checking whether each of the potential delegates is available for the event; for each of the potential delegates who is available for the event, comparing the predefined parameter values for the potential delegate to corresponding characteristics of the event and removing, from remaining potential delegates, each potential delegate for whom the predefined parameter values do not match the corresponding characteristics of the event; determining whether the remaining potential delegates are ranked with reference to at least one of the characteristics of the event; responsive to determining that the remaining potential delegates are ranked with reference to at least one of the characteristics of the event, iteratively sending a delegation request to a next-highest-ranked one of the remaining potential delegates and obtaining a response to the delegation request, until the obtained response indicates successful delegation of the event or there are no more remaining potential delegates; and responsive to determining that the remaining potential delegates are not ranked with reference to any of the characteristics of the event, sending the delegation request to each of the remaining potential delegates and obtaining the response to the delegation request.

In one embodiment, the automated delegation is used with an electronic calendar application. In another embodiment, the automated delegation is used with an email application. In either of these embodiments, the updated status of the event that indicates the delegation may further identify the potential delegate, or a plurality of potential delegates, to whom the delegation was successful; or, the updated status of the event that indicates the failure of the delegation attempt may further identify each potential delegate to whom the delegation was attempted when delegation has failed.

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 provides a flowchart depicting logic which may be used when implementing an embodiment of the present invention;

FIG. 2 depicts a data processing system suitable for storing and/or executing program code; and

FIG. 3 depicts a representative networking environment in which one or more embodiments of the present invention may be used.

### DETAILED DESCRIPTION OF THE INVENTION

Embodiments of the present invention are directed toward automated delegation and may be used, by way of example, with an electronic calendar application to delegate attendance at a meeting or other event and with an email application to delegate responsibility for handling an inbound email message. (Note also that the term “meeting” is used herein in a general sense to describe an event to which an invitee is invited using an electronic calendaring system invitation, and that this term is used by way of illustration and not of limitation. Embodiments of the present invention may be used advantageously for delegating attendance to any type of event—such as classes, field trips, and so forth—without deviating from the scope of the present invention.)

When using known electronic calendaring systems, meeting delegation may be a manual function whereby a meeting invitee receives a meeting invitation, and upon detecting a conflict (whether by manually inspecting his or her electronic calendar, or by receiving a conflict notification from the calendaring system), the invitee has to manually search for someone to whom the meeting attendance can be delegated (including sending a delegation request to a person who is asked to serve as the delegate, evaluating the response, possibly coordinating with the person to negotiate the delegation, deciding who to ask next if that person declines, and so forth). Or, a known calendaring system may provide automated delegation to a previously-defined person or group, which generally causes all subsequently-received meeting invitations to be delegated to that person or group.

Known techniques for delegation when using electronic calendar applications have various drawbacks. Typically, existing calendaring systems remove the meeting entry from the electronic calendar of the original meeting invitee, responsive to the delegation. It thus becomes difficult for the original meeting invitee to manage the meeting coverage once the agreement to delegate attendance is reached. If the meeting is rescheduled, for example, notification of the new schedule will generally be sent only to the delegate—and accordingly, the original meeting invitee is not presented with an opportunity to attend the now-rescheduled meeting. Or, if the calendaring system is configured to send notifications to the original invitee as well as the delegate, existing systems generally require that the original invitee explicitly activates the delegation prior to receiving the meeting invitation, as mentioned above. And as will be appreciated, the manual delegation approach requires a considerable amount of time and effort for the person who undertakes to do the delegation, as noted above.

An embodiment of the present invention is directed toward a “smarter” automated delegation, as contrasted to known systems, whereby previously-defined parameter values are used to automatically select a potential delegate or delegates. In a meeting delegation scenario, an embodiment of the present invention allows the original meeting invitee to manage the meeting coverage once the agreement with the delegate is reached.

Suppose, as an example scenario, that a department manager has multiple employees who each have varied roles, skill levels, and expertise, and that the manager would like to have these employees attend meetings in the manager's place when the manager is unable to attend (e.g., due to a scheduling conflict). Ideally, the manager would like to automatically delegate the meeting attendance to an employee with the appropriate job role, skill level, and expertise. Who is deemed to be “appropriate” as a delegate for attending a particular meeting in place of the original meeting invitee may depend on various characteristics of the scheduled meeting, such as the type of invitation, meeting importance, meeting audience, or topics on the meeting agenda. The original meeting invitee—who is the manager, in the example scenario—will typically retain responsibility for the meeting, even though a delegate will attend, and thus it is preferable for the original meeting invitee to maintain visibility of a calendar entry for the meeting as well as the delegation status of the meeting.

Using an embodiment of the present invention, the manager defines parameter values for meeting delegation in advance. These parameter values preferably comprise identifying a group of potential delegates and specifying one or more keywords that characterize each potential delegate (for example, in terms of role, skill level, and expertise). A graphical user interface may be provided to prompt the manager for entry of such parameter values. In one aspect, a ranking approach may be used, whereby the potential delegates are ranked with respect to various characteristics. The manager may enter his view of each potential delegate's rank, with respect to one or more such characteristics. (Note that while discussions herein refer to a “manager” as the original meeting invitee and “employees” as the potential delegates, this is by way of illustration and not of limitation. Embodiments of the present invention may be advantageously used by meeting invitees and delegates in other roles without deviating from the scope of the present invention.)

Continuing with the example scenario, once the manager has delegation information set up for potential delegates, when the manager subsequently receives a meeting invitation that he is unable to accept, the calendar delegation function as disclosed herein is employed to automatically delegate the meeting attendance. In one aspect, an embodiment of the present invention places a meeting notice on the manager's electronic calendar for reference, with an indication that the meeting is in the process of being delegated. Thus, the manager is able to maintain an awareness of the scheduled meeting, and can determine when a delegate has been located who accepts responsibility for attending the meeting.

In one embodiment, the electronic calendaring system as disclosed herein pulls in the pre-defined user parameter values entered by the manager to determine to whom to delegate the meeting, based on characteristics such as the subject of the meeting invitation (which may be determined through keywords, flags, etc.). If ranking is used, then the system preferably first sends the delegation request to the highest-ranked one of the potential delegates. If this person rejects the request, or does not respond within an allotted time period (when using an optional time-out feature), then the system automatically sends another request to the next-highest-ranked one of the potential delegates, in an iterative manner, until either a potential delegate responds positively or no delegate can be found (e.g., because the system times out or exhausts all delegation options). Or, if all potential delegates are ranked equally, then the delegation request is preferably sent to all of them at generally the same time, and the meeting is preferably delegated to the first potential delegate who responds positively (although in an alternative approach, the delegation may be accepted by more than one potential delegate). In a case where no delegate is found, an embodiment of the present invention preferably sends a notification to the manager (as the original meeting invitee) to alert him that the invitation has not been successfully delegated. The meeting notice on the manager's electronic calendar is preferably updated to reflect this most-recent status.

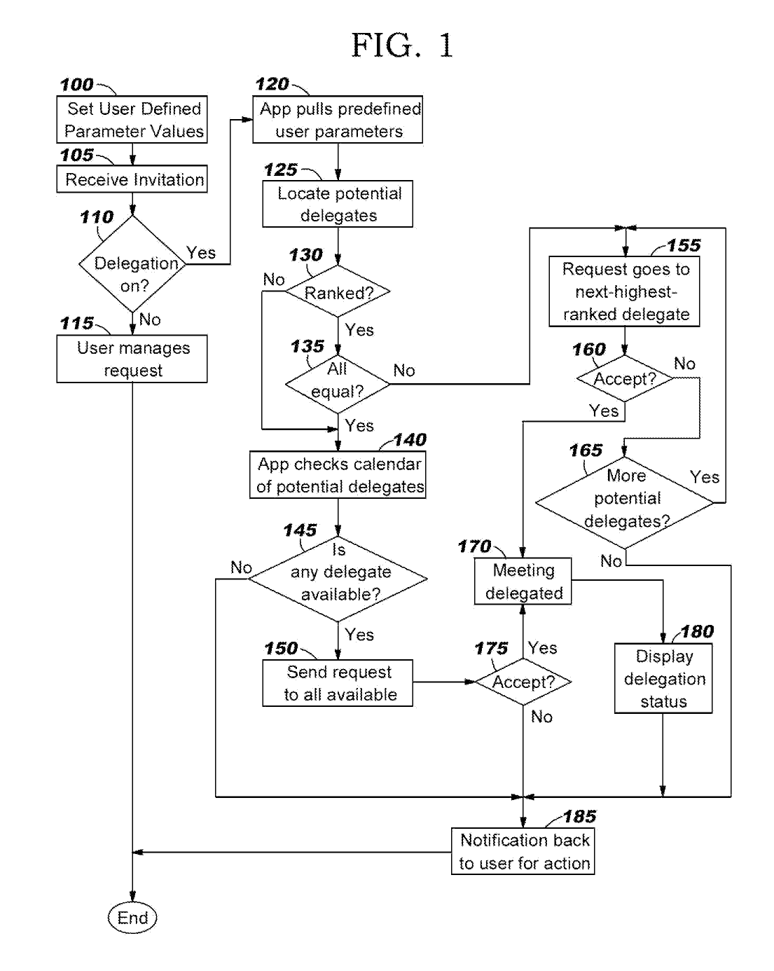

Referring now to FIG. 1, a flowchart is provided depicting logic which may be used when implementing an embodiment of the present invention for use with an electronic calendar application. As shown therein, the process begins with a calendar owner (e.g., the manager in the above-described example) setting user-defined delegation parameter values (Block 100). These parameter values may comprise, for example, keywords describing characteristics such as the role, skills, and/or expertise of each potential meeting delegate who is to be considered when delegation is needed or desired by this calendar owner. As an example, if the potential delegates are employees in a software development department, one or more keywords might be associated with each employee to indicate meeting topics that are best handled by that employee. Thus, if a meeting is scheduled to discuss quality issues with modules “X” and “Y”, by way of example, a delegate can be automatically selected who is best able to participate in that meeting.

The predefined user parameter values may additionally, or alternatively, comprise values for one or more categories or user preferences. Values for categories may be assigned in a similar manner to that which is described above for characteristics such as roles, skills, and expertise. Examples include a meeting subject, a meeting priority (such as low, medium, or high), and parameter values describing conditions pertaining to the potential delegate's calendar availability.

Optionally, ranking values may be assigned as well when the calendar owner sets the user-defined parameter values. For example, for a potential delegate whose role is salesperson, that person's expertise might be separately ranked as to each of several product lines marketed by the salesperson's company. In the software development example, it may happen that multiple people are able to serve as delegates in the meeting to discuss quality issues on a particular project, but some of these people are more capable than others.

At some subsequent time, the calendar owner's electronic calendar system receives a meeting invitation (Block 105). As noted earlier, this decision may be automated, or it may be made by the calendar owner (e.g., by pressing a “Delegate” button which is displayed on the calendar application user interface). A decision is made (Block 110) as to whether attendance at this meeting is to be delegated. If the meeting attendance will not be delegated, then control transfers to Block 115, which indicates that the calendar owner will manage the meeting invitation (e.g., the meeting will be added to the electronic calendar, and the calendar owner will then be personally responsible for attending the meeting). The processing of FIG. 1 then ends for this meeting invitation. On the other hand, when the test at Block 110 has a positive result, processing continues at Block 120.

The automated delegation processing begins at Block 120 by programmatically obtaining the predefined user parameter values for this calendar owner. Block 125 then locates the potential delegates for this calendar owner. Preferably, this comprises a filtering process whereby the predefined parameter values for each potential delegate are compared to keywords (or similar attributes) of the meeting invitation, and potential delegates that do not pass this filtering process may be removed from further consideration. For example, if the calendar owner has characterized a set of potential delegates by meeting topics for which each person is a qualified delegate, and an invitation arrives for a meeting on a topic that matches the predefined topics for only a subset of the potential delegates, then it may be desired to not consider the non-matching people as potential delegates. Accordingly, such persons are not considered in the further processing of FIG. 1.

Block 130 tests whether the potential delegates are ranked. In an embodiment that does not support ranking, this test will have a negative result. The test may also have a negative result when ranking is supported, but has not been used for the potential delegates. Upon a negative result, control transfers to Block 140. When Block 130 has a positive result, however, Block 135 then tests whether it happens that the rankings for all of the potential delegates are equal. Control also transfers to Block 140 upon a positive result for this test. Otherwise—that is, when the delegates are ranked, but the rankings are not equal—control transfers to Block 155.

Block 140 is reached when the potential delegates do not have different rankings. Accordingly, Block 140 checks the electronic calendar for each of the potential delegates with reference to the scheduled meeting that is to be delegated. Block 145 tests whether any potential delegate is available according to this check of their respective electronic calendars. If none of the potential delegates are available (i.e., the test at Block 145 has a negative result), then control transfers to Block 185, where a notification of a failed delegation attempt is preferably sent to the original meeting invitee. The status of the meeting on the original meeting invitee's electronic calendar is preferably updated, as discussed earlier, to indicate the current status of the delegation attempt. This may comprise displaying an indicator, such as a text string stating “failed” or “not delegated”. The processing of FIG. 1 then ends for this meeting invitation.

When the test at Block 145 has a positive result (i.e., at least one potential delegate is available, according to the check of their respective electronic calendars), Block 150 sends a delegation request to all potential delegates who are available. Block 175 then tests whether a potential delegate accepted the delegation. If not (i.e., the test at Block 175 has a negative result), processing preferably continues at Block 185 to notify the original meeting invitee that the delegation failed and update the calendar entry status (as discussed above), after which the processing of FIG. 1 ends.

Note that the test in Block 175 may have a negative result due to time-out, rather than due to failure to receive a positive response for any potential meeting delegate. Use of a time limit for this processing is optional, and serves to place a bound on the amount of time spent waiting for a response.

When the test at Block 175 has a positive result, indicating that a potential delegate accepted the delegation, then Block 170 denotes the meeting as having been delegated. This preferably comprises updating the electronic calendar of the original meeting invitee to reflect this now-delegated meeting, along with a status indicating that the meeting has been delegated. Additional information may be indicated as well, such as a name or other identifier of the delegate(s).

Block 180 displays the calendar entry with its current status (assuming that the electronic calendar is currently being displayed). A dashboard-type view may be provided, which displays various information pertaining to delegation—including, for example, a list of meetings which are delegated and the delegate(s) for that meeting, a list of meetings for which delegation is currently being processed (and optionally, identification of the potential delegates and their current delegation status), and a list of meetings for which delegation was unsuccessful (and optionally, a list of the potential delegates for which this delegation did not succeed). Accordingly, embodiments of the present invention preferably enable the original meeting invitee to monitor and track meeting delegation.

Notably, the electronic calendar of the delegate who accepted the meeting delegation will also show the calendar entry, and this may optionally include a delegation status indicator (such as “attending as a delegate” or “attendance delegated from Manager”). For any potential delegates who did not accept the delegation, an embodiment of the present invention may optionally add an informational entry to that person's electronic calendar. Processing then continues at Block 185 to notify the original meeting invitee that the delegation was successful, after which the processing of FIG. 1 ends.

Referring now to Block 155, this processing is reached when the potential delegates are ranked, but the rankings are different for at least two of the potential delegates. Accordingly, Block 155 selects the highest-ranked potential delegate and sends a delegation request to that person. Block 160 tests whether the delegation request is accepted. If the test at Block 160 has a positive result, then processing continues at Block 170, where the meeting is denoted as having been delegated, as has been discussed above. On the other hand, when the test at Block 160 has a negative result (i.e., the potential delegate did not accept the delegation), then Block 165 checks whether there are any more potential delegates. If not, then control transfers to Block 185 to notify the original meeting invitee that the delegation failed.

Note that the test in Block 160 may have a negative result due to time-out, rather than due to failure to receive a positive response from the potential meeting delegate. Use of a time limit for this processing is optional, and serves to place a bound on the amount of time spent waiting for a response.

When the test at Block 165 has a positive result, indicating that there are still more potential delegates farther down in the rankings, then the processing of Blocks 155-160 is repeated in an iterative manner for the next-highest-ranked potential delegate. In a preferred approach, this iterative process will end when then are no more potential delegates to evaluate, or when one of the potential delegates accepts the delegation.

As can be seen by the above discussion, an embodiment of the present invention provides for a smarter way to manage delegation, as contrasted to known electronic calendaring systems. In particular, a calendar owner's electronic calendaring system will automatically choose who is best suited to attend a specific delegated meeting, based on the predefined user parameter values, and will allow the meeting delegate(s) to see a calendar entry for the meeting while continuing to allow the original meeting invitee to see a similar calendar entry (with an indication of the delegation status).

While embodiments of the present invention have been described with reference to FIG. 1 as being provided for an electronic calendar application, this is by way of illustration and not of limitation. In one other approach, the disclosed techniques may be used with an email application.

In this alternative approach, responsibility for handling inbound email messages can be delegated with reference to predefined user parameter values and characteristics of the inbound messages (such as message topic, message priority, and message content). Accordingly, a particular inbound email message is forwarded to a suitable delegate (or delegates), in view of the predefined user parameter values (including ranking among the potential delegates, if supported by an embodiment), or if no suitable delegate can be found, then the inbound email message is not forwarded and the original recipient remains responsible for handling the inbound message. The logic depicted in FIG. 1 may be adapted to provide analogous delegation processing for email, whereby Block 105 then pertains to receiving an inbound email message; Block 140 checks whether the potential delegates are available for email delegation (including, for example, whether the person is out of the office); Block 170 indicates that handling of the email has been delegated; Block 180 performs a forwarding of the delegated email to the selected delegate(s); and Block 185 notifies the original email recipient as to whether the handling of an inbound email was delegated.

Embodiments of the present invention may operate at least partially on a client machine (e.g., on an end-user device executing an electronic calendar application or an email application) and may operate at least partially on a server machine (e.g., on a back-end device that manages electronic calendar information for a plurality of calendar users or that manages email messages for a plurality of users).

As will be appreciated by one of skill in the art, embodiments of the present invention may be provided as (for example) methods, systems, and/or computer program products. The invention can take the form of an entirely hardware embodiment, an entirely software embodiment, or an embodiment containing both hardware and software elements. In a preferred embodiment, the invention is implemented in software, which includes (but is not limited to) firmware, resident software, microcode, etc. Furthermore, the present invention may take the form of a computer program product which is embodied on one or more computer-usable storage media (including, but not limited to, disk storage, CD-ROM, optical storage, and so forth) having computer-usable program code embodied therein, where this computer program product may be used by or in connection with a computer or any instruction execution system. For purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (“RAM”), a read-only memory (“ROM”), a rigid magnetic disk, and an optical disk. Current examples of optical disks include compact disk read-only memory (“CD-ROM”), compact disk read/write (“CD-R/W”), and DVD.

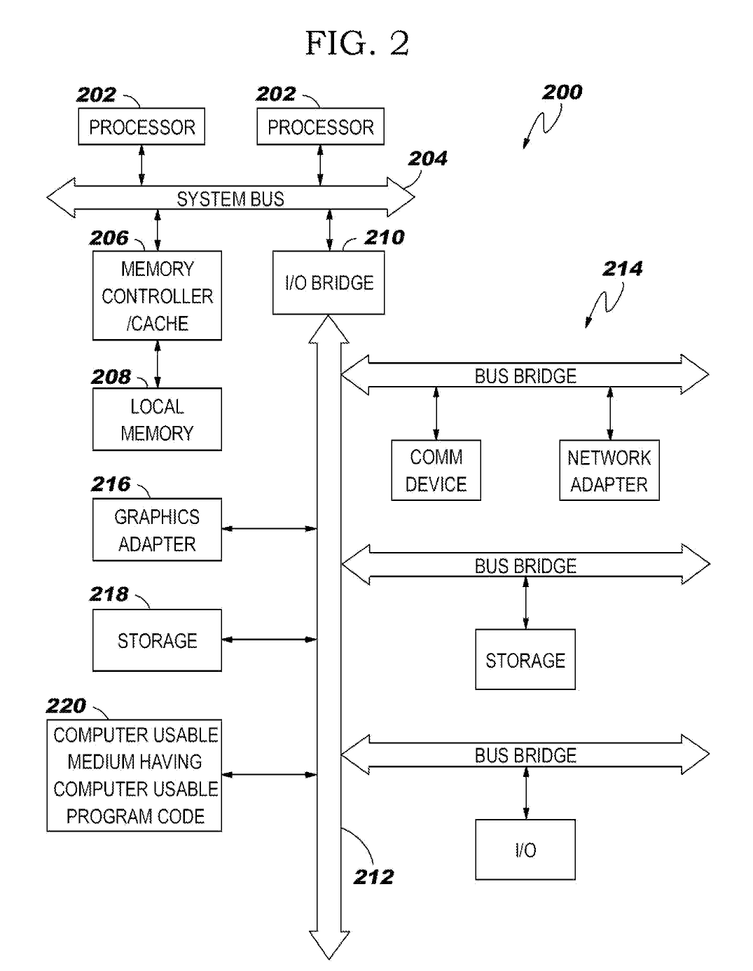

Referring now to FIG. 2, a block diagram of a data processing system is depicted in accordance with the present invention. Data processing system 200, such as one of the processing devices described herein, may comprise a symmetric multiprocessor (“SMP”) system or other configuration including a plurality of processors 202 connected to system bus 204. Alternatively, a single processor 202 may be employed. Also connected to system bus 204 is memory controller/cache 206, which provides an interface to local memory 208. An I/O bridge 210 is connected to the system bus 204 and provides an interface to an I/O bus 212. The I/O bus may be utilized to support one or more buses 214 and corresponding devices, such as bus bridges, input output devices (“I/O” devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 216, storage 218, and a computer usable storage medium 220 having computer usable program code embodied thereon. The computer usable program code may be executed to execute any aspect of the present invention, as have been described herein.

The data processing system depicted in FIG. 2 may be, for example, an IBM System p® system, a product of International Business Machines Corporation in Armonk, N.Y., running the Advanced Interactive Executive (AIX®) operating system. An object-oriented programming system such as Java may run in conjunction with the operating system and provides calls to the operating system from Java® programs or applications executing on data processing system. (“System p” and “AIX” are registered trademarks of International Business Machines Corporation in the United States, other countries, or both. “Java” is a registered trademark of Oracle America, Inc., in the United States, other countries, or both.)

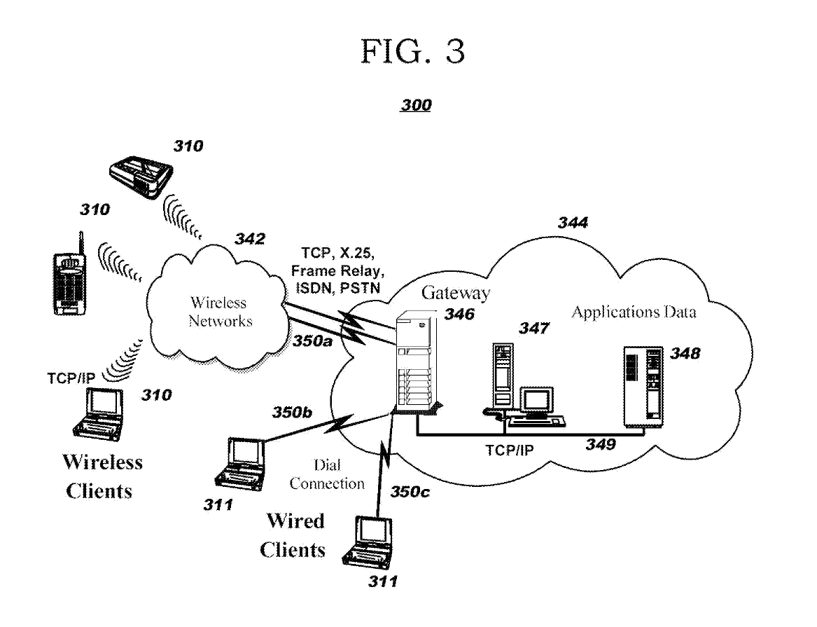

FIG. 3 illustrates a data processing network environment 300 in which the present invention may be practiced. The data processing network 300 may include a plurality of individual networks, such as wireless network 342 and wired network 344. A plurality of wireless devices 310 may communicate over wireless network 342, and a plurality of wired devices, shown in the figure (by way of illustration) as workstations 311, may communicate over network 344. Additionally, as those skilled in the art will appreciate, one or more local area networks (“LANs”) may be included (not shown), where a LAN may comprise a plurality of devices coupled to a host processor.

Still referring to FIG. 3, the networks 342 and 344 may also include mainframe computers or servers, such as a gateway computer 346 or application server 347 (which may access a data repository 348). A gateway computer 346 serves as a point of entry into each network, such as network 344. The gateway 346 may be preferably coupled to another network 342 by means of a communications link 350a. The gateway 346 may also be directly coupled to one or more workstations 311 using a communications link 350b, 350c, and/or may be indirectly coupled to such devices. The gateway computer 346 may be implemented utilizing an Enterprise Systems Architecture/390® computer available from IBM. Depending on the application, a midrange computer, such as an iSeries®, System i™, and so forth may be employed. (“Enterprise Systems Architecture/390” and “iSeries” are registered trademarks, and “System i” is a trademark, of IBM in the United States, other countries, or both.)

The gateway computer 346 may also be coupled 349 to a storage device (such as data repository 348).

Those skilled in the art will appreciate that the gateway computer 346 may be located a great geographic distance from the network 342, and similarly, the devices 310, 311 may be located some distance from the networks 342 and 344, respectively. For example, the network 342 may be located in California, while the gateway 346 may be located in Texas, and one or more of the devices 310, 311 may be located in Florida. The devices 310 may connect to the wireless network 342 using a networking protocol such as the Transmission Control Protocol/Internet Protocol (“TCP/IP”) over a number of alternative connection media, such as cellular phone, radio frequency networks, satellite networks, etc. The wireless network 342 preferably connects to the gateway 346 using a network connection 350a such as TCP or User Datagram Protocol (“UDP”) over IP, X.25, Frame Relay, Integrated Services Digital Network (“ISDN”), Public Switched Telephone Network (“PSTN”), etc. The devices 311 may connect directly to the gateway 346 using dial connections 350b or 350c. Further, the wireless network 342 and network 344 may connect to one or more other networks (not shown), in an analogous manner to that depicted in FIG. 3.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages such as the “C” programming language or similar programming languages. The program code may execute as a stand-alone software package, and may execute partly on a user's computing device and partly on a remote computer. The remote computer may be connected to the user's computing device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method for automated delegation, comprising:
defining parameter values for each of a plurality of potential delegates;
responsive to a subsequent request for delegating an event, automatically attempting a delegation using the predefined parameter values for the potential delegates, comprising:
checking whether each of the potential delegates is available for the event;
for each of the potential delegates who is available for the event, comparing the predefined parameter values for the potential delegate to corresponding characteristics of the event and removing, from remaining potential delegates, each potential delegate for whom the predefined parameter values do not match the corresponding characteristics of the event;
determining whether the remaining potential delegates are ranked with reference to at least one of the characteristics of the event;
responsive to determining that the remaining potential delegates are ranked with reference to at least one of the characteristics of the event, iteratively sending a delegation request to a next-highest-ranked one of the remaining potential delegates and obtaining a response to the delegation request, until the obtained response indicates successful delegation of the event or there are no more remaining potential delegates; and
responsive to determining that the remaining potential delegates are not ranked with reference to any of the characteristics of the event, sending the delegation request to each of the remaining potential delegates and obtaining the response to the delegation request; and
if any obtained response indicates successful delegation of the event, updating a status of the event to indicate the delegation and otherwise, updating the status of the event to indicate failure of the delegation attempt.

2. The method according to claim 1, wherein the subsequent request is triggered by an electronic calendar application receiving a request to schedule the event on an electronic calendar of a calendar owner and detecting that the calendar owner has a conflict with the event.

3. The method according to claim 2, wherein the event is a meeting.

4. The method according to claim 3, wherein the characteristics of the event comprise at least one of: a type of the meeting; a topic of the meeting; an importance of the meeting; and an agenda of the meeting.

5. The method according to claim 1, wherein the parameter values comprise at least one of:
a role of the potential delegate; a skill of the potential delegate; and an expertise of the potential delegate.

6. The method according to claim 1, wherein:
the subsequent request is triggered by an email application receiving an inbound email message for an email recipient for whom the delegation is requested; and
the event comprises handling of the inbound email message.

7. The method according to claim 6, wherein the characteristics of the event comprise at least one of: a topic of the inbound email message; an importance of the inbound email message; and content of the inbound email message.

8. The method according to claim 1, wherein the updated status of the event that indicates the delegation further identifies the potential delegate to whom the delegation was successful.

9. The method according to claim 1, wherein the updated status of the event that indicates the delegation further identifies each of a plurality of the potential delegates to whom the delegation was successful.

10. The method according to claim 1, wherein the updated status of the event that indicates the failure of the delegation attempt further identifies each potential delegate to whom the delegation was attempted.

11. A computer-implemented system for automated delegation, comprising:
a computer comprising a processor; and
instructions which are executable, using the processor, to implement functions comprising:
defining parameter values for each of a plurality of potential delegates;
responsive to a subsequent request for delegating an event, automatically attempting a delegation using the predefined parameter values for the potential delegates, comprising:
checking whether each of the potential delegates is available for the event;
for each of the potential delegates who is available for the event, comparing the predefined parameter values for the potential delegate to corresponding characteristics of the event and removing, from remaining potential delegates, each potential delegate for whom the predefined parameter values do not match the corresponding characteristics of the event;
determining whether the remaining potential delegates are ranked with reference to at least one of the characteristics of the event;
responsive to determining that the remaining potential delegates are ranked with reference to at least one of the characteristics of the event, iteratively sending a delegation request to a next-highest-ranked one of the remaining potential delegates and obtaining a response to the delegation request, until the obtained response indicates successful delegation of the event or there are no more remaining potential delegates; and
responsive to determining that the remaining potential delegates are not ranked with reference to any of the characteristics of the event, sending the delegation request to each of the remaining potential delegates and obtaining the response to the delegation request; and
if any obtained response indicates successful delegation of the event, updating a status of the event to indicate the delegation and otherwise, updating the status of the event to indicate failure of the delegation attempt.

12. The system according to claim 11, wherein the subsequent request is triggered by an electronic calendar application receiving a request to schedule the event on an electronic calendar of a calendar owner and detecting that the calendar owner has a conflict with the event.

13. The system according to claim 11, wherein:
the subsequent request is triggered by an email application receiving an inbound email message for an email recipient for whom the delegation is requested; and
the event comprises handling of the inbound email message.

14. The system according to claim 11, wherein the updated status of the event that indicates the delegation further identifies each of at least one of the potential delegates to whom the delegation was successful.

15. The system according to claim 11, wherein the updated status of the event that indicates the failure of the delegation attempt further identifies each potential delegate to whom the delegation was attempted.

16. A computer program product for automated delegation, the computer program product comprising:
a computer readable storage medium having computer readable program code embodied therein, the computer readable program code configured for:
defining parameter values for each of a plurality of potential delegates;
responsive to a subsequent request for delegating an event, automatically attempting a delegation using the predefined parameter values for the potential delegates, comprising:
checking whether each of the potential delegates is available for the event;
for each of the potential delegates who is available for the event, comparing the predefined parameter values for the potential delegate to corresponding characteristics of the event and removing, from remaining potential delegates, each potential delegate for whom the predefined parameter values do not match the corresponding characteristics of the event;
determining whether the remaining potential delegates are ranked with reference to at least one of the characteristics of the event;
responsive to determining that the remaining potential delegates are ranked with reference to at least one of the characteristics of the event, iteratively sending a delegation request to a next-highest-ranked one of the remaining potential delegates and obtaining a response to the delegation request, until the obtained response indicates successful delegation of the event or there are no more remaining potential delegates; and
responsive to determining that the remaining potential delegates are not ranked with reference to any of the characteristics of the event, sending the delegation request to each of the remaining potential delegates and obtaining the response to the delegation request; and
if any obtained response indicates successful delegation of the event, updating a status of the event to indicate the delegation and otherwise, updating the status of the event to indicate failure of the delegation attempt.

17. The computer program product according to claim 16, wherein the subsequent request is triggered by an electronic calendar application receiving a request to schedule the event on an electronic calendar of a calendar owner and detecting that the calendar owner has a conflict with the event.

18. The computer program product according to claim 16, wherein:
the subsequent request is triggered by an email application receiving an inbound email message for an email recipient for whom the delegation is requested; and
the event comprises handling of the inbound email message.

19. The computer program product according to claim 16, wherein the updated status of the event that indicates the delegation further identifies each of at least one of the potential delegates to whom the delegation was successful.

20. The computer program product according to claim 16, wherein the updated status of the event that indicates the failure of the delegation attempt further identifies each potential delegate to whom the delegation was attempted.
